(19) United States
(12) Patent Application Publication
(10) Pub. No.: US 2004/0224552 A1
(43) Pub. Date: Nov. 11, 2004

(54) Solderless multiconductor cable connector

(75) Inventors: Bernd Hagmann, Geislingen (DE); Othmar Gaidosch, Ostfildern (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co. KG

(21) Appl. No.: 10/763,055

(22) Filed: Jan. 22, 2004

(30) Foreign Application Priority Data
Jan. 23, 2003 (DE) 10302712.2
May 26, 2003 (DE) 10323616.3

(51) Int. Cl. H01R 13/58

(52) U.S. Cl. 439/461

(57) ABSTRACT

A connector has a front insulating body, a contact fixed in the main body and having rear-end parts forming an axially open seat adapted to receive a conductor of a stripped wire and radially displaceable toward each other, and structure radially compressing the parts toward each other to grip the conductor. This structure is an intermediate body formed with an axially tapered passage fitting over the rear-end parts and axially displaceable to displace the rear-end parts radially toward one another.

### FIELD OF THE INVENTION

The present invention relates to a cable connector. More particularly this invention concerns a cable connector, that is plug or socket, that can be connected without soldering to the conductors of a multiwire cable.

### BACKGROUND OF THE INVENTION

A multiconductor connector of the solderless type, whether formed as a socket with a group of contact sleeves or as a plug with a group of contact pins, is typically used at the end of a shielded or unshielded cable comprised of a plurality of wires held in a common insulating sheath and each in turn having a central conductor formed typically of a plurality of strands and insulation sleeve surrounding the conductor strands. The connector has a body in which several contacts are set, each formed at one end as a pin or sleeve and at the other end as some sort of terminal for connection of the respective conductor of the cable.

In quick-mount systems, as opposed to systems where the terminal connections must be made individually by screws or solder, the standard arrangement entails the provision of a contact spike. The individual wires of the cable are fitted to respective seats in the conductor body, and then the spikes are forced through the insulation into the conductors of the respective wires. The spike may stick transversely through the individual conductors or, as described U.S. Pat. No. 5,755,789, axially into the end thereof. Either way, once the connection is made, the outer cable sheath is secured to the connector so that the conductors do not pull off the respective connector spikes.

Such arrangements have several difficulties. First, they can be fairly bulky, especially when the terminal spikes are effective transversely. Second, the connection can loosen with time, even through the simple effect of thermal expansion and contraction that leaves the spike fitting loosely in the hole it is has poked in the respective conductor and in poor contact therewith. Third, such arrangements frequently cannot easily create a connection with a cable shield or ground, especially when the shield is a tubular braid underlying the outer insulating sheath.

### OBJECTS OF THE INVENTION

It is therefore an object of the present invention to provide an improved multiconductor cable connector.

Another object is the provision of such an improved multiconductor cable connector which overcomes the above-given disadvantages, that is which is easy to hook up and disconnect, that ensures good long-term engagement of the terminals and the respective conductors, and that can easily connect with a cable shield.

### SUMMARY OF THE INVENTION

A connector has according to the invention a front insulating body, a contact fixed in the main body and having rear-end parts forming an axially open seat adapted to receive a conductor of a stripped wire and radially displaceable toward each other, and structure radially compressing the parts toward each other to grip the conductor. This structure is an intermediate body formed with an axially tapered passage fitting over the rear-end parts and axially displaceable to displace the rear-end parts radially toward one another.

Thus with this system a wire of the cable is stripped to expose its conductor, and this stripped conductor is fitted to the seat of the contact. Then the structure is displaced to radially inwardly compress the parts of the contact, thereby clamping the conductor solidly in the contact. This system therefore provides for actual gripping of the contact with an arrangement that is very compact. The gripping ensures that the conductor will remain in good engagement with the contact over a long time. What is more, the connector can be assembled on a cable without the use of tools other, of course, than any used to prepare the cable. The connector according to the invention can comply with IP67 standard according to IEC60529 or can be an E-series connector according to IEC61076-2-101. It can handle data transmission in the gigabyte range,

The intermediate body according to the invention is displaceable axially between a position spaced axially from the front body and not radially compressing the parts and a position bearing on the front body and radially compressing the parts toward one another. In addition the connector further has according to the invention a sleeve coaxially surrounding the bodies and axially coupled thereto. This sleeve is conductive and the cable has conductive shielding surrounding the wire. An electrically conductive element in the sleeve radially presses on the shielding and is in electrical contact with the sleeve. Thus the shielding is connected to the sleeve, thereby ensuring a continuous shielding of the conductors as they pass through the connector. This electrically conductive element is an iris spring.

The connector further has according to the invention a rear body formed with an axially throughgoing passage and fittable with the intermediate body with its passage aligned with the intermediate body passage. The rear-body passage has a front end of a relatively small diameter corresponding generally to a diameter of the conductor and a rear end of a relatively large diameter corresponding generally to a diameter of the insulation. Thus the stripped wire is inserted in the rear-body passage and only its stripped conductor can project past the front end, making it impossible for the insulation to get between the contact rear parts and the conductor.

According to the invention a sleeve coaxially surrounds the bodies and is axially coupled thereto. The sleeve and one of the bodies have formations rotationally coupling them together.

The front body in accordance with the invention has axially rearwardly projecting fingers extending through the intermediate body and fitting with the rear body. The intermediate body is displaceable axially between a rear position spaced axially from the front body and not radially compressing the parts and a front position bearing on the front body and radially compressing the parts toward one another. The fingers are snap fitted with the rear body in the front position and lock the bodies against relative axial displacement. Thus the bodies are locked together on the stripped wire ends to make the necessary electrical connection.

### BRIEF DESCRIPTION OF THE DRAWING

The above and other objects, features, and advantages will become more readily apparent from the following description, reference being made to the accompanying drawing in which:

FIG. 1 is a side view of the connector according to the invention;

FIG. 2 is a larger-scale axial section taken along line II-II of FIG. 1;

FIG. 3 is an end view taken in the direction of arrow III of FIG. 1;

FIG. 4 is a large-scale section taken along line IV-IV of FIG. 3;

FIG. 5 is a perspective view from the front of the connector and a cable;

FIG. 6 is a large-scale side view of a single contact;

FIG. 7 is a section taken along line VII-VIII of FIG. 6;

FIG. 8 is a cross section taken along line VIII-VIII of FIG. 6;

FIG. 9 is a large-scale view of the detail indicated at IX in FIG. 7;

FIG. 10 is a large-scale view of the detail indicated at X in FIG. 7;

FIG. 11 is a perspective view from the rear of the contact;

FIG. 12 is a perspective view from the rear of the front body part;

FIG. 13 is a view like FIG. 12 but partly in axial section;

FIG. 14 is a large-scale view of the detail indicated at XIV in FIG. 13;

FIG. 15 is a partly sectional perspective view from the rear of the middle body part;

FIG. 16 is a partly sectional perspective view from the front of the middle body part;

FIG. 17 is a large-scale view of the detail indicated at XVII in FIG. 15;

FIG. 18 is a partly sectional perspective view from the rear of the rear body part;

FIG. 19 is a perspective view from the front of the rear body part;

FIG. 20 is a partly sectional perspective view from the back of the main or middle part of the body sleeve;

FIG. 21 is a partly sectional perspective view from the front of the middle part of the body sleeve;

FIG. 22 is a perspective side view of the washer; and

FIG. 23 is a perspective side view of the spring.

### SPECIFIC DESCRIPTION

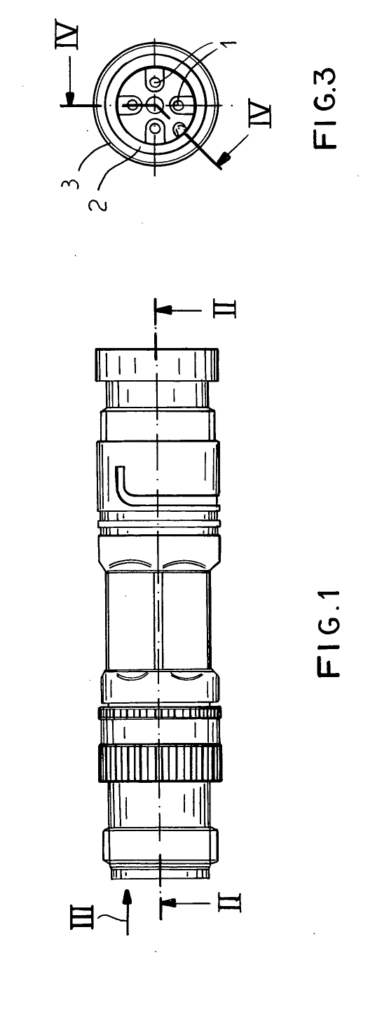

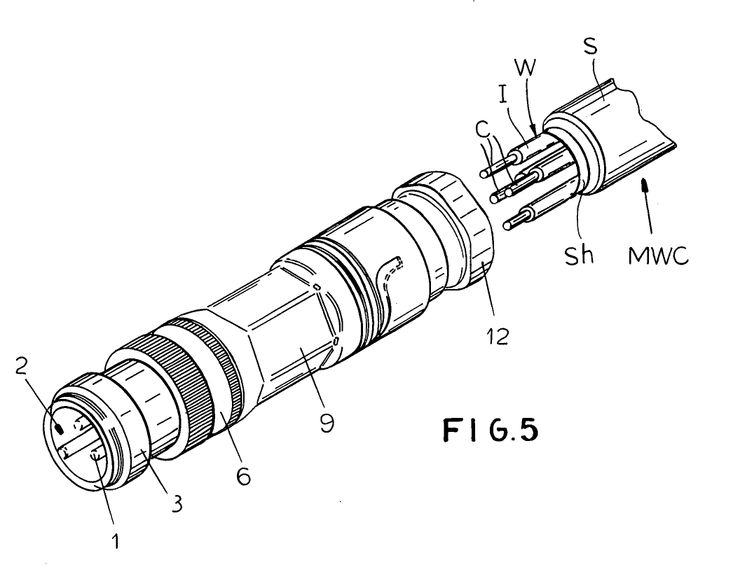

As seen in FIGS. 1 through 5 a connector according to the invention is basically formed as a plug intended to be mounted on the end of a multiwire cable MWC (FIG. 5) having a plastic sheath S holding four wires W each having a plastic insulating sheath I and a metallic stranded-wire conductive core C. A tubular shielding braid Sh surrounds the wires W inside the sheath S. The insulation I has been stripped off the ends of the stranded-wire cores C. The connector could also of course be part of a sensor, actuator, control device, or the like.

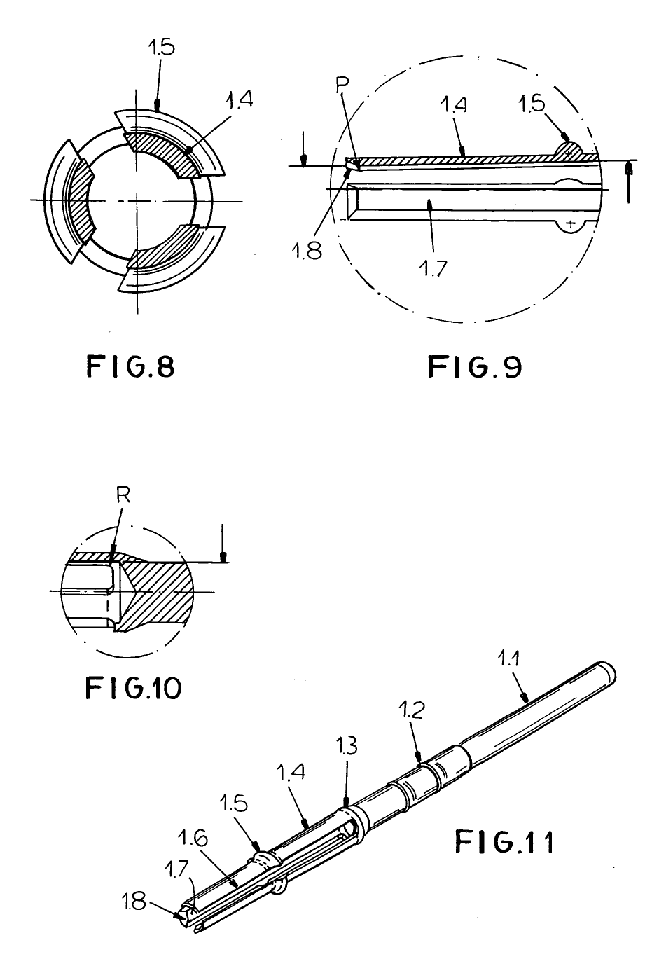

The connector is centered on an axis A and basically comprises four contacts 1 set in an insulating plastic front or main body 2 held in place by a metallic front-end sleeve 3 bearing via a conductive washer 4 (FIG. 7 also) on a coupling nut 6 itself threaded to a main sleeve 9. The front body 2 is axially fixed to a rear body 8 and can press an intermediate body 7 backward to clamp the stripped conductors C in rear ends of the terminals 1 as will be described below. An iris spring 10 (FIG. 8 also) ensures contact between the shielding Sh of the cable MWC and the conductive main body sleeve 9. A sleeve-shaped seal 11 and strain-relief element 12 can be pressed by a tightening nut 13 against the outer surface of the cable sheath S to lock it solidly in place in the connector.

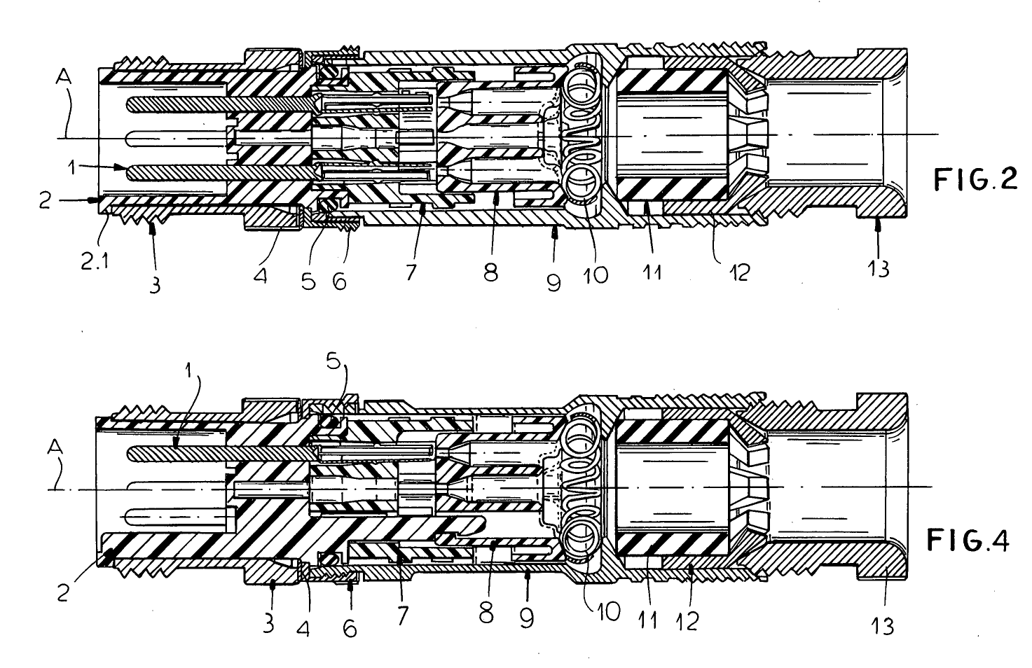

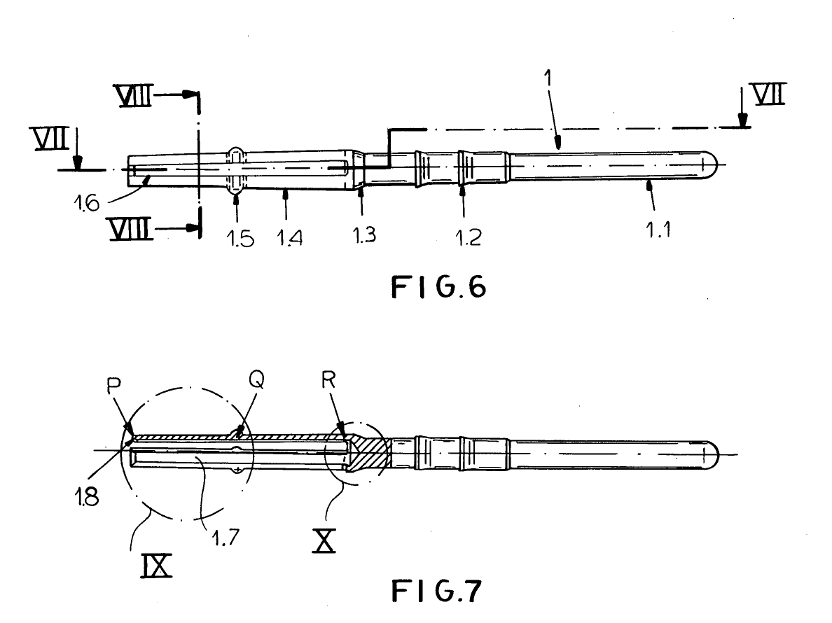

FIGS. 6-11 show one of the contacts 1 in detail. It has a front end 1.1 here formed as a round-end contact pin, but that could also be formed as a contact sleeve, solder lug, hybrid contact, or the like. Centrally it is formed with radially outwardly projecting ridges 1.2 that ensure that it will be axially solidly seated in the front body 2 in which it is imbedded normally by molding the front body 2 around the contacts 1. A forwardly directed frustoconical shoulder 1.3 bears as shown in FIGS. 2 and 4 on a rear face of the front body 2 to further prevent the contact 1 from shifting forward. The rear end of the contact 1 is formed by three identical tongues 1.4 angularly equispaced from each other, each having a central radially outwardly projecting ridge 1.5, and separated by axially rearwardly open notches 1.6. Thus the tongues 1.4 of each contact define an axially rearwardly open blind seat 1.7 into which the stripped conductor C of a respective wire W is inserted. The rear ends of the tongues 1.4 are internally beveled at 1.8 to facilitate insertion of the conductors into the respective seat 1.7.

The seats 1.7 are each dimensioned such that they have a radial dimension DP at the rear end that is smaller than a dimension DQ at the ridges 1.5 that in turn is smaller than the dimension DR at the blind front end of the seat 1.7, so that DP≦DQ≦DR. The elasticity of the metal forming the tongues 1.4 is such relative to the distance between points P, Q, and R that a radially inwardly directed force on the ridges 1.5 will exert a sufficient force at P where the tongues 1.4 grip the conductor C that they will maintain a long-term solid connection, with the tongues 1.4 in effect spring-biased against the conductor C. In fact the diameter DP is normally close to the diameter of the conductor C so that under normal circumstances there is some natural spring-biasing of the tongues 1.4 against the respective conductor C.

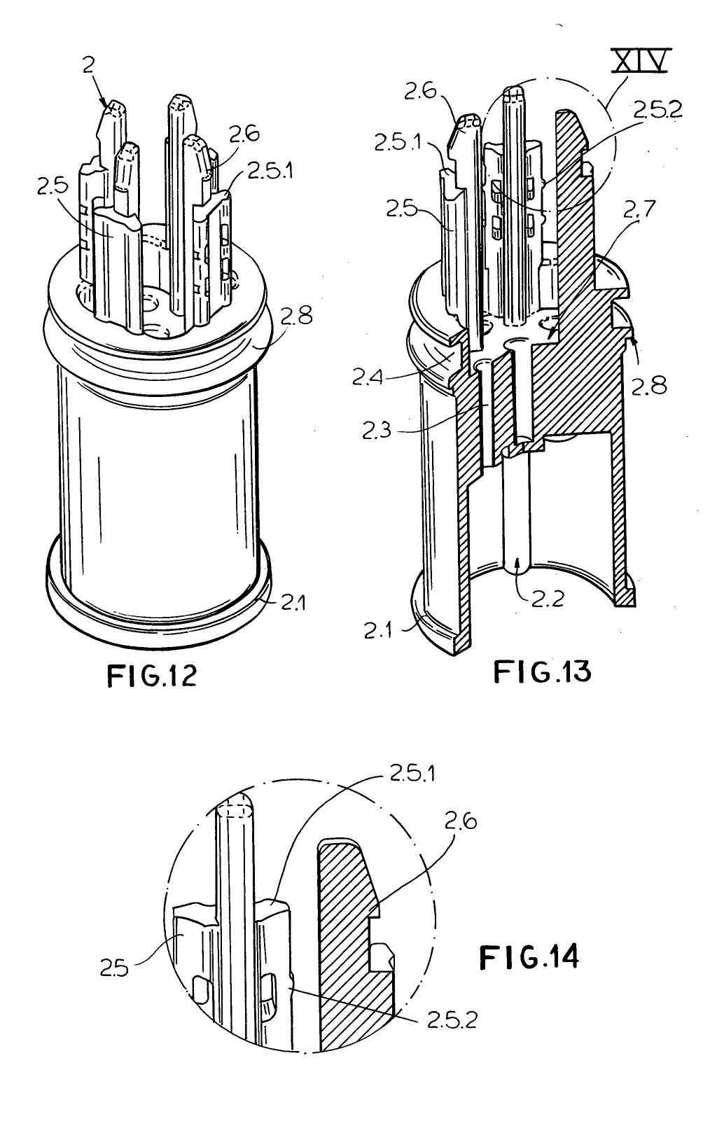

FIGS. 12-14 show the front body 2 in more detail. It has a front-end radially outwardly projecting ridge 2.1 serving as an abutment for the sleeve 3 and a radially extending inwardly projecting ridge 2.2 adapted to fit with a plug or socket fittable in the front end to align it angularly. Four axially throughgoing holes 2.3 hold the contacts 1 and a radially outwardly open groove 2.4 holds the O-ring 5. An axially forwardly directed shoulder 2.8 on this body 2 bears on the nut 6 to axially couple the front body 2 to the nut 6. Projecting rearward from the front body 2 are four identical retaining fingers 2.5 having outwardly directed end barbs 2.6, end faces 2.5.1, and side bumps 2.5.2 that engage as described below in the rear body 8 which sits against a rear end face 2.7 of the front body 2. These fingers 2.5 serve to fix the bodies 2, 7, and 8 together and secure them in the end of the sleeve 9.

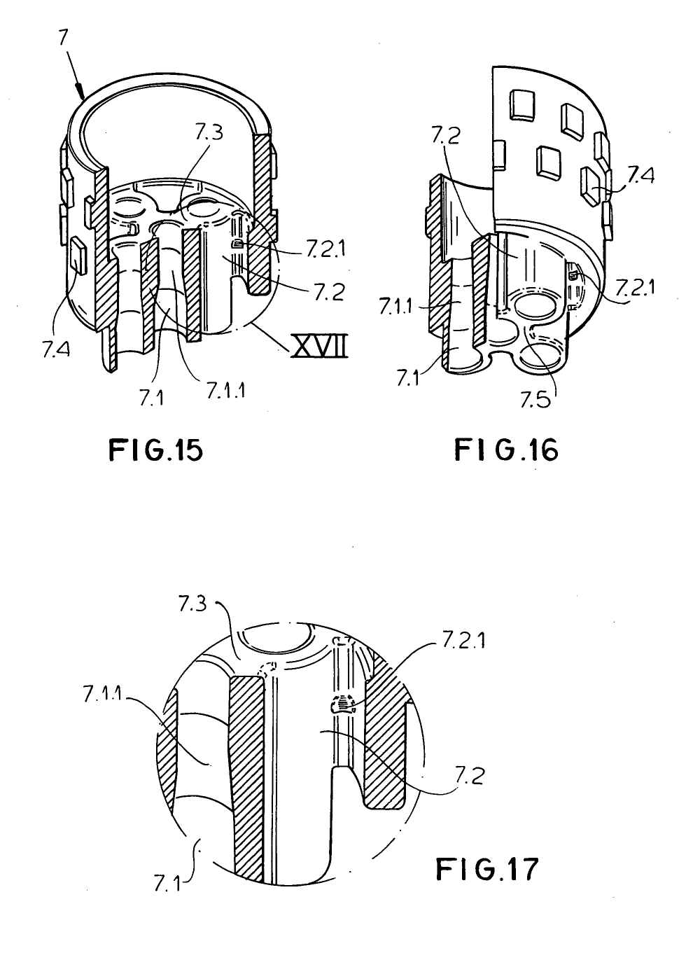

The intermediate body 7 is shown in FIGS. 15-17. It is formed for each contact 1 with an axially throughgoing passage 1.7 that flares forward and tapers backward from a central point 7.1.1 so as to be able to engage the ridges 1.5 and press the tongues 1.4 radially inward. It is further provided with guide holes 7.2 complementary to the fingers 2.5, including recesses 7.2.1 into which the bumps 2.5.2 can fit. The fingers 2.5 engage as shown in FIG.4 completely through the passages and into the rear body 8 as will be described below. The intermediate body 7 has radially outwardly projecting square bumps 7.4 that center it in the sleeve 9 and a front end face 7.5 that can bear against the rear end face 2.7 of the front body 2.

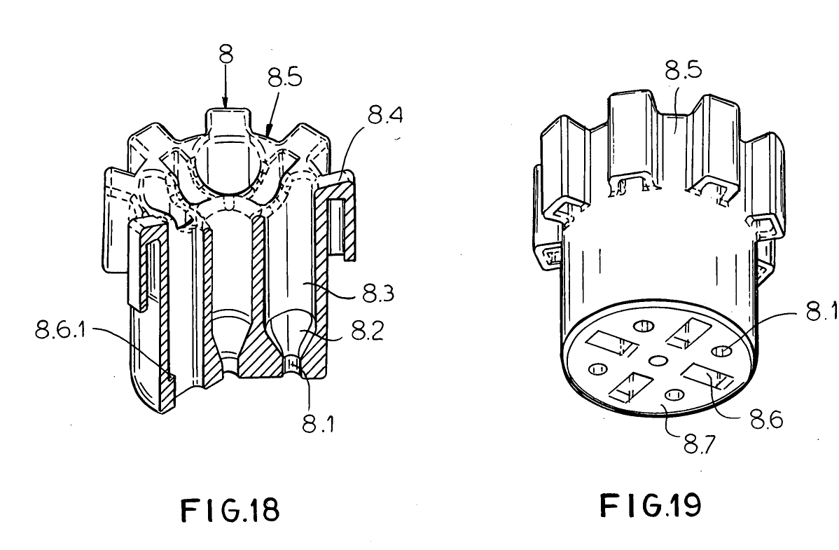

The rear body 8 is shown in FIGS. 18 and 19. It has four holes 8.1 aligned with the holes 7.1 and connected via rearwardly flaring regions 8.2 with rearwardly open holes 8.3 of larger diameter. The holes 8.1 and 8.3 are respectively dimensioned to snugly receive the core C and the insulation I of one of the wires, with the tapered region 8.2 serving to guide the core C into the seat 1.7 of the respective contact 1. In addition the rear body 8 has eight radially outwardly projecting ribs 8.4 that center it in the sleeve 9, that are separated by empty spaces 8.5, and that form a forwardly tapering frustoconical seat for the iris spring 10. The rear body 8 is also formed with four axially throughgoing passages 8.6 complementary to the ends of the fingers 2.5 and having shoulders 8.6.1 on which the barbs 2.6 of the fingers 2.5 can engage to lock the front body 2 to the rear body 8, with the intermediate body 7 gripped between them and an end face 8.6 of the rear body 8 bearing on the rear ends of the contacts 1.

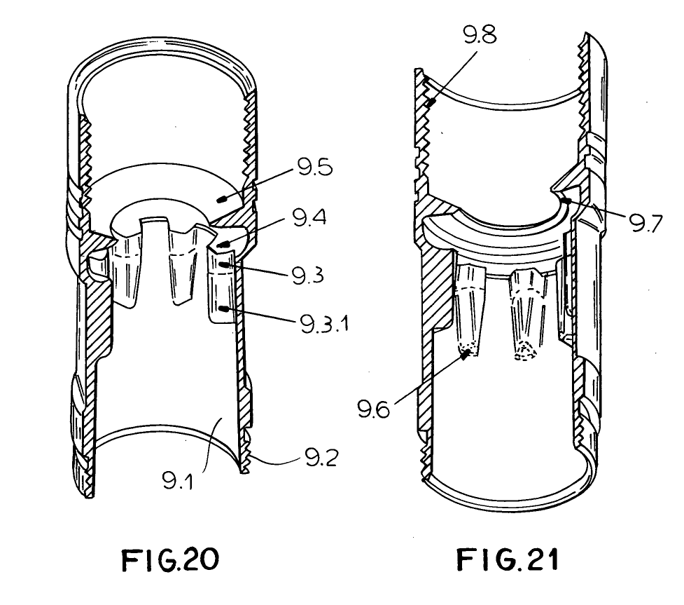

The main sleeve 9 is shown in FIGS. 20 and 21. It is made of metal or is metal coated so that it is conductive. It has a cylindrical front part 9.1 that holds the parts 2, 7, and 8, that acts as a seal surface for the O-ring 5, and that is formed with an external screwthread 9.2 for the nut 6. Internally it has radially inwardly projecting ridges 9.3 that have forwardly tapering front ends 9.3.1 that fit complementarily in the spaces 8.5 to rotationally couple the rear body 8 to the sleeve 9, thereby also angularly coupling the bodies 2 and 7 to the sleeve 9. A radially inwardly open groove 9.4 immediately rearward of the ridges 9.3 acts as a seat for the iris spring 10, and a rearwardly directed and forwardly tapering frustoconical seat 9.5 serves for radially compressing the seal 11 when the nut 13 is tightened. An internal screwthread 9.8 mates with an external screwthread for the clamping nut 13. End surfaces 9.6 of the ridges 9.3 bear in fully assembled condition on the rear end of the intermediate body 7.

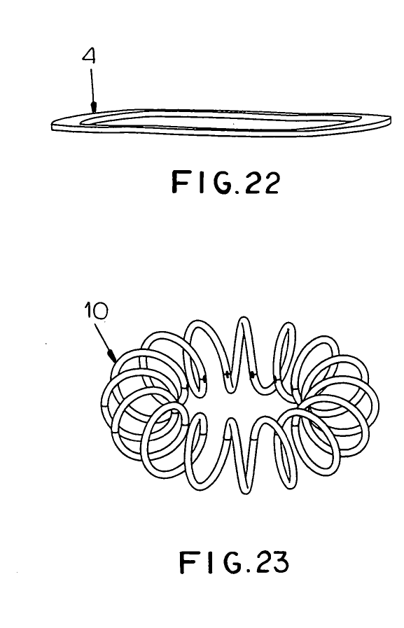

FIG. 22 shows the washer 22 which is somewhat wavy, that is not perfectly planar and flat, so as to maintain a good electrical contact between the sleeve 3 and nut 6. The iris spring 10 shown in FIG. 23 serves to make a good electrical contact between the shielding Sh of the cable MWC and the sleeve 9, and thence through the nut 6 to the front-end sleeve 3 so that when the sleeve 3 is threaded into another element there is a continuous ground.

The connector is typically supplies to the user as four subassemblies:

Complete contact carrier including contacts 1, front body 2, nut/sleeves 3 and 6, wsher4, O-ring 5, middle body 7, and rear body 8.

Sleeve including main sleeve part 9 and spring 10, although these parts can be supplied separately.

Strain relief including seal 11 and strain-relieve element 12.

Nut 13.

The connector is put together with the Cable MWC after first stripping back the sheath S rather far, stripping back the shielding Sh so it projects well past the sheath S but not to the ends of the wires 2, and stripping the insulation I off the wires W with the insulation 1 still projecting well past the shielding Sh. Then the nut 13, the strain-relief element 12, the seal 11, and the sleeve 9 slipped over the end of the stripped cable MWC. The intermediate body 7 is set on the front body 2 and the rear body 8, but with the intermediate body 7 spaced from the rear body 8 so its tapering bores 7.1 to not radially compress the fingers 1.4 of the contacts 1 together. Then the wires W are fitted through the holes 8.1-8.3 of the rear body 8 to force the conductors C into the seats 7.1.

The main body 2 is then pressed axially rearward toward the rear body 8 to simultaneously fit the fingers 2.5 through the holes 7.2 and snap their barbs 2.6 over the shoulders 8.6.1. This action radially compresses the tongues 1.4 so they bear elastically on the respective conductors C, making an excellent electrical contact therewith.

Then the nut 13 is screwed tight so as to radially compress the seal 11 and strain-relief element 12 against the outer surface of the sheath S, thereby solidly locking the cable MWC to the connector. Meanwhile the shielding S will have entered into good contact with the conductive spring 10 and, through it, with the sleeves 9, 6, and 3.

As mentioned, the connector of this invention can also be mounted directly on a housing, in which case the parts 10, 11, 12, and L3 are not necessary. In addition the solid pin ends 1.1 of the contacts 1 can be formed as sockets into which pins are fit, without leaving the scope of the invention.

We claim:

1. A connector comprising:
a front insulating body;
a contact fixed in the main body and having rear-end parts forming an axially open seat adapted to receive a conductor of a stripped wire and radially displaceable toward each other; and
means for radially compressing the parts toward each other to grip the conductor.

2. The connector defined in claim 1 wherein the means is an intermediate body formed with an axially tapered passage fitting over the rear-end parts and axially displaceable to displace the rear-end parts radially toward one another.

3. The connector defined in claim 2 wherein the intermediate body is displaceable axially between a position spaced axially from the front body and not radially compressing the parts and a position bearing on the front body and radially compressing the parts toward one another.

4. The connector defined in claim 2, further comprising
a sleeve-coaxially surrounding the bodies and axially coupled thereto.

5. The connector defined in claim 2, wherein the sleeve is conductive and the cable has conductive shielding surrounding the wire, the connector further comprising
an electrically conductive element in the sleeve radially pressing on the shielding and in electrical contact with the sleeve.

6. The connector defined in claim 5 wherein the electrically conductive element is an iris spring.

7. The connector defined in claim 2, further comprising
a rear body formed with an axially throughgoing passage and fittable with the intermediate body with its passage aligned with the intermediate-body passage.

8. The connector defined in claim 7 wherein the rear-body passage has a front end of a relatively small diameter corresponding generally to a diameter of the conductor and a rear end of a relatively large diameter corresponding generally to a diameter of the insulation.

9. The connector defined in claim 8, further comprising
a sleeve coaxially surrounding the bodies and axially coupled thereto.

10. The connector defined in claim 9 wherein the sleeve and one of the bodies have formations rotationally coupling them together.

11. The connector defined in claim 7 wherein the front body has axially rearwardly projecting fingers extending through the intermediate body and fitting with the rear body.

12. The connector defined in claim 11 wherein the intermediate body is displaceable axially between a rear position spaced axially from the front body and not radially compressing the parts and a front position bearing on the front body and radially compressing the parts toward one another, the fingers being snap fitted with the rear body in the front position and locking the bodies against relative axial displacement.

13. The connector defined in claim 2 wherein the contact parts are a plurality of angularly spaced and rearwardly projecting elastic tongues each having a central radially outwardly projecting ridge engageable with an inside surface of the middle-body passage.

14. The connector defined in claim 13 wherein the contact has at least three of the tongues angularly equispaced about the seat.
